(19) United States
(12) Patent Application Publication
(10) Pub. No.: US 2017/0222931 A1
(43) Pub. Date: Aug. 3, 2017

(54) DYNAMIC ALLOCATION OF FLOW TABLE CAPACITY

(71) Applicant: Hewlett Packard Enterprise Development LP, Houston, TX (US)

(72) Inventors: Yoshio Turner, San Francisco, CA (US); Jose Renato G. Santos, Morgan Hill, CA (US); Hyojoon Kim, Palo Alto, CA (US)

(21) Appl. No.: 15/500,260

(22) PCT Filed: Sep. 29, 2014
(86) PCT No.: PCT/US2014/057937

§ 371 Date: Jan. 30, 2017

(51) Int. Cl. H04L 12/801; H04L 12/741

(52) U.S. Cl. CPC H04L 47/12; H04L 45/745

(57) ABSTRACT

Examples relate to dynamic allocation of flow table capacity. In some examples, packet-in events of a networking device are monitored and processed to create active flow entries in a flow table. After detecting that the packet-in events at the networking device exceed an overload threshold, the active allocation of the flow table is increased. At this stage, a backup flow is removed from the flow table based on the active allocation.

### BACKGROUND

A software defined network (SDN) is a computer networking methodology that has distinct systems for deciding where traffic should be sent (i.e., control plane) and forwarding the traffic to the selected destinations (i.e., data plane). In contrast, typical networking devices (e.g., switches, routers, etc.) are integrated systems that both determine destinations and forward the traffic. Because the underlying infrastructure is abstracted, the controller of an SDN can be centrally managed and programmed directly.

### BRIEF DESCRIPTION OF THE DRAWINGS

The following detailed description references the drawings, wherein:

FIG. 1 is a block diagram of an example controller device for providing dynamic allocation of flow table capacity;

FIG. 2 is a block diagram of an example system for providing dynamic allocation of flow table capacity;

FIG. 3 is a flowchart of an example method for execution by a controller device for providing dynamic allocation of flow table capacity; and

FIG. 4 is a flowchart of an example method for execution by a controller device for providing dynamic allocation of flow table capacity.

### DETAILED DESCRIPTION

As discussed above, SDN allows networking infrastructure to be centrally managed and programmed. Flow tables of SDN-enabled switches have limited capacity, which is measured based on the number of flow table entries. To forward traffic flows, flow table entries are configured at each switch along the path used by each flow. In case of failure, traffic flows that use paths affected by the failure should be moved to backup routes to restore connectivity between the flow endpoints. For fast failover, entries corresponding to the flows that are moved can be established at each switch along the backup routes prior to the failure event.

Examples disclosed herein automatically determine the number of active flow entries and backup flow entries that should be used at each switch to avoid overflowing the flow table at each switch while simultaneously limiting the load on the SDN controller due to packet-in events and also limiting failover time in case of failure. In some cases, packet-in events of a networking device are monitored and processed to create active flow entries in a flow table. After detecting that the active flows on the networking device exceed an overload threshold, the active allocation of the flow table is increased. At this stage, a backup flow is removed from the flow table based on the active allocation.

In particular, in an “active-active” configuration, links or switches that are on primary paths for some flows are also on backup paths for other flows. Accordingly, the flow table capacity at these switches is shared between entries for both types, primary and backup routes. Because the flow table capacity is limited, it may not be possible to store entries for all active flows that use a switch along with entries for all flows that may need to failover to a path that uses the same switch. In this case, a procedure can be implemented as described herein to determine how many flow table entries and the particular entries of each type that should be maintained.

Excluding flow entries for active flows increases the load on the SDN controller because, if a packet arrives at a switch and there is no matching rule, the packet is forwarded to the SDN controller for processing (referred to herein as a “packet-in event”). Specifically, the SDN controller may process the packet by installing the missing entries once the failure is detected, which can be a lengthy procedure. If the entries are pre-installed before the failure, the failover delay could be avoided, resulting in lower downtime for workloads using the network. A SDN should ensure there are enough flow entries reserved for active flows to avoid overloading the SDN controller with too many packet-in events. Thus, examples described below dynamically modify the active allocation of networking devices based on the rate of packet-in events.

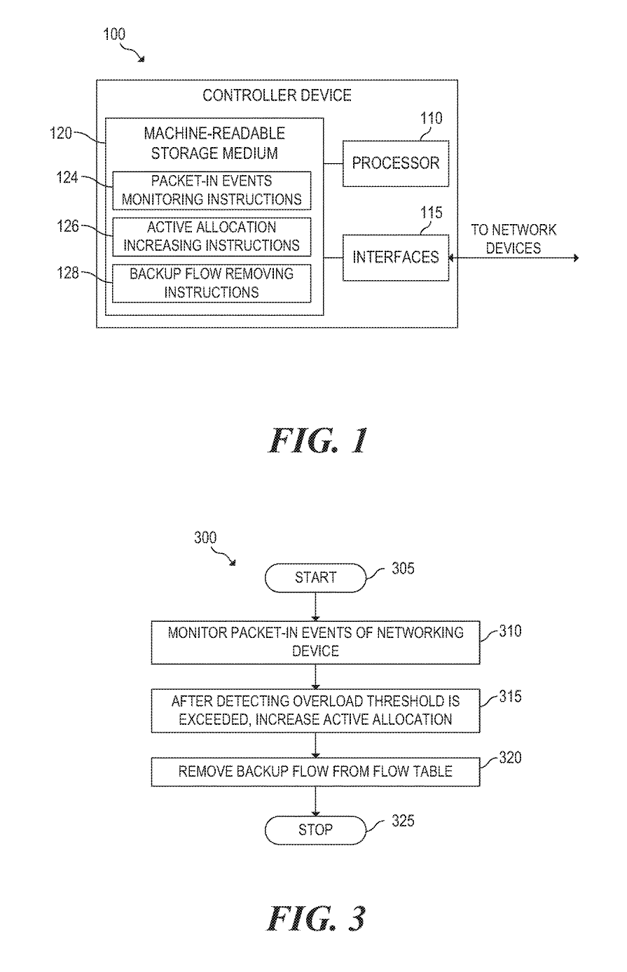

Referring now to the drawings, FIG. 1 is a block diagram of an example controller device 100 for providing dynamic allocation of flow table capacity. The example controller device 100 may be a computing device (e.g., server, desktop computer, etc.), a networking device (e.g., a switch, a router, a hub, a repeater, a bridge, etc.), or any other electronic device suitable for managing networking devices in an SDN network. In the embodiment of FIG. 1, controller device 100 includes processor 110, interfaces 115, and machine-readable storage medium 120.

Processor 110 may be one or more central processing units (CPUs), microprocessors, and/or other hardware devices suitable for retrieval and execution of instructions stored in machine-readable storage medium 120. Processor 110 may fetch, decode, and execute instructions 124, 126, 128 to enable providing dynamic allocation of flow table capacity, as described below. As an alternative or in addition to retrieving and executing instructions, processor 110 may include one or more electronic circuits comprising a number of electronic components for performing the functionality of one or more of instructions 124, 126, 128.

Interfaces 115 may include a number of electronic components for communicating with networking device. For example, interfaces 115 may be wireless interfaces such as wireless local area network (WLAN) interfaces and/or physical interfaces such as Ethernet interfaces, Universal Serial Bus (USB) interfaces, external Serial Advanced Technology Attachment (eSATA) interfaces, or any other physical connection interface suitable for communication with the networking device. In operation, as detailed below, interfaces 115 may be used to send and receive data to and from networking devices.

Machine-readable storage medium 120 may be any electronic, magnetic, optical, or other physical storage device that stores executable instructions. Thus, machine-readable storage medium 120 may be, for example, Random Access Memory (RAM), Content Addressable Memory (CAM), Ternary Content Addressable Memory (TCAM), an Electrically-Erasable Programmable Read-Only Memory (EEPROM), flash memory, a storage drive, an optical disc, and the like. As described in detail below, machine-readable storage medium 120 may be encoded with executable instructions for providing dynamic allocation of flow table capacity.

Each networking device may include a flow table that stores forwarding table entries defining routes to destinations in the SDN. For example, a flow table entry may specify that packets destined for a particular destination end-point device should be forwarded to a port that is associated with a neighboring networking device. In another example, a flow table entry may point to a group table entry, which can be used to route traffic from a networking device. For example, one type of group table is a fast failover table that defines a set of ordered buckets, where each bucket is associated with a port. In this example, each flow can be associated with a fast failover group, and packets are routed to the first live bucket in the group, where live indicates that the corresponding port is operational. The fast failover table allows for fast route changes in the event of local link/port failures.

Packet-in events monitoring instructions 124 monitor packet-in events (e.g., “packet-in” event in OPENFLOW®) to determine the frequency that new flow table entries are being created for active flows. A switch generates a packet-in event when a packet arrives and there is no matching flow table entry installed at the switch. In this case, the controller processes the packet-in event by installing a matching flow table entry in the networking device to handle subsequent packets that have matching header values. Entries can be removed from the table explicitly by the controller, or entries can be removed by the networking device if the entries time out due to lack of use if the entries are configured with a timeout value.

OPENFLOW® is a registered trademark of the Open Networking Foundation non-profit corporation, which is headquartered in Beaverton, Oreg. The OPENFLOW protocol provides centralized access to the forwarding plane of an SDN. The OPENFLOW protocol supports group tables as described herein.

In this example, the packet-in events monitoring instructions 124 continually monitors the rate of packet-in events generated by each networking device in the SDN network. When the rate of packet-in events at a particular networking device is above an overload threshold, active allocation increasing instructions 126 shift the networking device to a mode that favors using flow table entries for active flow entries rather than for backup flow entries. A high rate of packet-in events can disrupt overall network performance due to controller delays; therefore, it is more important to relieve the load on controller device 100 than it is to ensure fast failover.

For example, backup flow removing instructions 128 can gradually remove old backup flow table entries to make room for new active flow table entries on networking devices with full flow tables rather than evicting older active flow entries. In this example, backup flow removal may be based on the flow usage statistics of the corresponding active flow, which is configured on a different networking device from the backup flow. In another example, controller device 100 avoids pre-populating backup flow table entries for new active flows. In this case, it is very likely to increase failover time in case of failures because active flows will not have pre-installed backup flow table entries. Accordingly, controller device 100 typically exercises the first option in the first example initially while continuing to install new backup flow entries. However, if high load persists on controller device 100, it can additionally refrain from installing new backup flow entries for new active flows.

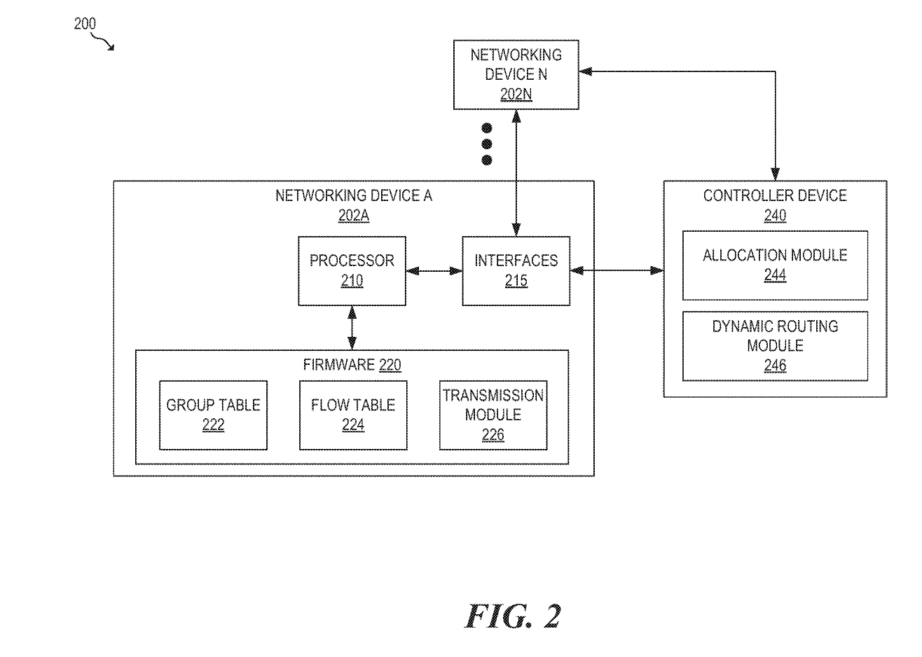

FIG. 2 is a block diagram of an example system 200 including networking devices (e.g., networking device A 202A, networking device N 202N) interacting with controller device 240 to provide a SDN. The components of controller device 240 may be similar to the corresponding components of controller device 100 described with respect to FIG. 1. System 200 includes user devices networking devices (e.g., networking device A 202A, networking device N 202N) and controller device 240.

As illustrated, networking device A 202A may include processor 210, interfaces 215, arid firmware 220. Processor 210 and interfaces 215 may be similar to the corresponding components of controller device 100 that are described above with respect to FIG. 1. In this example, interfaces 215 communicate with (e.g., networking device A 202A, networking device N 202N) and controller device 240. Firmware 220 may include a number of modules 222-226, where each of the modules may include a series of instructions encoded on a machine-readable storage medium, which may be similar to machine-readable storage medium 120 of FIG. 1, and executable by processor 210. In addition or as an alternative, each module may include one or more hardware devices including electronic circuitry for implementing the functionality described below. Although the components of firmware 220 are described in detail below, additional details regarding an example implementation of firmware 220 are provided above in connection with instructions 122-128 of FIG. 1.

Group table 222 stores group table entries that define a group for transmitting data in corresponding route trees. Each group table entry is associated with actions that typically include a forward to port action that transmits data along its corresponding route tree. The route trees and group table 222 are configured by controller device 240 as described below.

Flow table 224 stores forwarding table entries that define routes to destinations in the SDN. For example, a flow table entry may specify that packets destined for a particular destination end-point device should be forwarded to a port that is associated with a neighboring networking device. In another example, a flow table entry may point to a group table entry, which can be used to route traffic from networking device A 202A.

Transmission module 226 forwards data packets to other devices in the SDN based on entries in group table 222 and flow table 224. Specifically, the destination of a packet may be used to query the flow table 224 to determine which port of networking device A 202A should be used to forward the packet. For example, transmission module 226 may use a group table entry to forward the packet upstream toward the root of a route tree associated with the group table entry. In another example, transmission module 226 may use a forwarding table entry to forward the packet downstream toward the destination end-point device of the route tree.

Transmission module 226 is also configured to detect transmission failures. In the event of a failure, transmission module 226 can collect metadata associated with the failure for sending in a transmission failure notification to controller device 240.

System 200 may include any number of networking devices (e.g., networking device A 202A, networking device N 202N) that are arranged in a variety of topologies. Each of the networking devices may be substantially similar to networking device A 202A. Specifically, each of the networking devices may be compliant with an SDN protocol that supports indirect group tables (e.g., group table 222). In some cases, the SDN may be a hybrid SDN, where some of the networking devices support the SDN protocol while others do not.

Controller device 240 may be a computing device that configured to manage an SDN including end-point devices (not shown) and networking devices (e.g., networking device A 202A, networking device N 202N). Controller device 240 may be, for example, a server, a networking device, or any other computing device suitable for managing traffic flow of an SDN. In this example, controller device 240 includes allocation module 244, and dynamic routing module 246.

Allocation module 244 configures the active allocation of networking devices (e.g., networking device A 202A, networking device N 202N) according to an overload and normal threshold. Active allocation is the amount of memory of a networking device that is dedicated to active flow entries. An overload threshold of the networking device specifies an amount of activity (e.g., rate of packet-in events) at which quality of the active flows degrades. Packet-in events of a networking device (e.g., networking device A 202A, networking device N 202N) are monitored by controller device 240 to determine if the overload threshold is exceeded. If the overload threshold is exceeded, a large number of active flow entries are created in response to the packet-in events, which adversely affects the performance of the SDN. If the overload threshold is exceeded at a networking device, allocation module 244 may increase the active allocation of the networking device. In some cases, a maximum value may be specified for the active allocation such that the active allocation cannot be increased to greater than the maximum value. Conversely, a normal threshold of the networking device specifies an amount of activity at which quality of the active flows returns to normal. If the normal threshold is achieved, allocation module 244 may return the active allocation to normal levels. In some cases, the overload threshold may be equal to the normal threshold such that the active allocation returns to normal levels if the normal threshold is achieved.

In some cases, allocation module 244 is configured to modify the active allocation gradually. For example, allocation module 244 can increase the active allocation on-demand (i.e., increase the active allocation by one for each new packet-in request). In another example, allocation module 244 can increase the active allocation in blocks based on timed events (i.e., increase the active allocation by a set amount at timed intervals). In yet another example, allocation module 244 can increase the active allocation in proportion to the number of packet-in events received that exceed the current active allocation. For example, if five packet-in events are received and the active allocation is exceeded by three at a networking device, allocation module 244 can increase the active allocation of the networking device by three.

Dynamic routing module 246 reconfigures the flow of traffic in the SDN. For example, if there is a failure in the SDN, dynamic routing module 246 may replace routes that include the failure with new routes. In another example, if a route tree has excessive traffic, some of the source and destination end-point device pairs of the overly loaded routes may be migrated to a less busy routes. Rerouting by dynamic routing module 246 may be limited by the active allocations configured as described above by allocation module 244. For example, if backup flow entries are not available on a networking device (e.g., networking device A 202A, networking device N 202N), dynamic routing module 246 may be unable to reroute failed paths in a timely manner.

FIG. 3 is a flowchart of an example method 300 for execution by a controller device 100 for providing dynamic allocation of flow table capacity. Although execution of method 300 is described below with reference to controller device 100 of FIG. 1, other suitable devices for execution of method 300 may be used such as controller device 240 of FIG. 2. Method 300 may be implemented in the form of executable instructions stored on a machine-readable storage medium, such as computer readable medium 120 of FIG. 1, and/or in the form of electronic circuitry.

Method 300 may start in block 305 and continue to block 310, where controller device 100 monitors packet-in events to determine the frequency that new flow table entries are being created for active flows. In block 315, the rate of packet-in events generated by each networking device in the SDN network are continually monitored and compared to an overload threshold.

If the overload threshold is exceeded, controller device 100 switches networking devices in the SDN to a mode that favors using flow table entries for active flow entries rather than for backup flow entries in block 320. Accordingly, controller device 100 gradually removes old backup flow table entries of networking devices to make room for new active flow table entries. Method 300 may then continue block 325, where method 300 may stop.

Method 300 may be applied separately to any number of networking devices in an SDN. In this case, controller device 100 monitors packet-in events at each networking device and adjusts the active allocation at each networking device as described above.

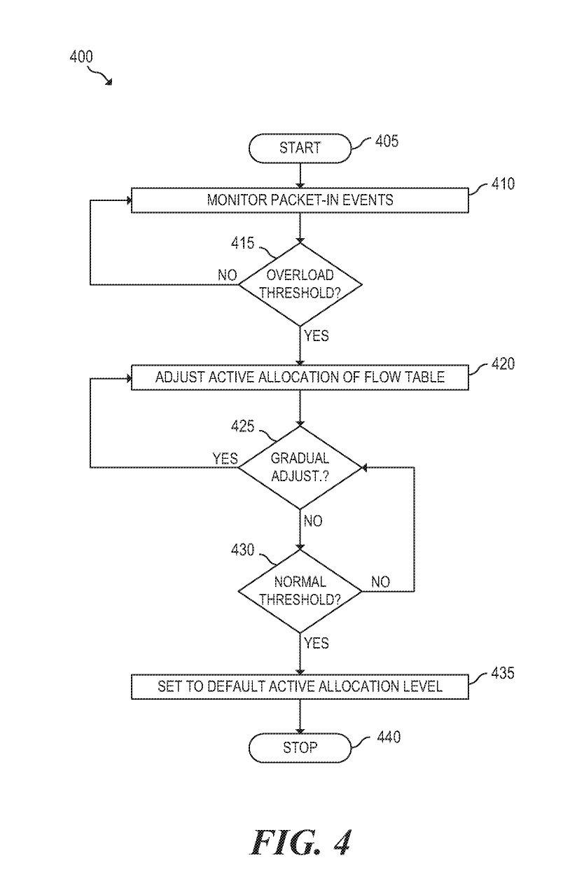

FIG. 4 is a flowchart of an example method 400 for execution by a controller device 240 for providing dynamic allocation of flow table capacity. Although execution of method 400 is described below with reference to controller device 240 of FIG. 2, other suitable devices for execution of method 400 may be used. Method 400 may be implemented in the form of executable instructions stored on a machine-readable storage medium and/or in the form of electronic circuitry.

Method 400 may start in block 405 and continue to block 410, where controller device 240 monitors packet-in events to determine the frequency that new flow table entries are being created for active flows at each networking device in the SDN. In block 415, controller device 240 determines if an overload threshold is exceeded at any of the networking devices in the SDN. If the overload threshold is not exceeded, method 400 returns to block 410, where controller device continues to monitor packet-in events.

If the overload threshold is exceeded, controller device 240 switches networking devices in the SDN to a mode that favors using flow table entries for active flow entries rather than for backup flow entries in block 420. Accordingly, inactive backup flow table entries are removed to make room for new active flow table entries on networking devices that exceed the overload threshold. Inactive backup flows can be identified based on flow usage statistics (e.g., number of active entries, number of packets looked up in table, number of packets that hit table, etc.) of a corresponding networking device. In some cases, the corresponding networking device is different from the networking device adjusted in block 420.

In block 425, controller device 240 determines if it should gradually adjust the active allocation of any networking devices. The determination can be based on timed intervals, a magnitude that the overload threshold is exceeded, further packet-in events, etc. If a gradual adjustment is triggered, method returns to block 420, where controller device 240 further increases the active allocation of the networking device. If a gradual adjust is not triggered, controller device 240 determines if a normal threshold has been achieved by any networking devices with increased active allocations. If no networking devices have achieved the normal threshold, method 400 returns to block 425. If a networking device has achieved the normal threshold, computing device 240 sets the active allocation to a default level in block 440. In this state, controller device 240 favors backup flow table entries over active flow table entries. Controller device 240 may gradually evict older, inactive flow table entries from switches with full tables and resumes installing backup flow entries for new active flows. Controller device 240 may also install backup flow table entries that were previously evicted when the overload threshold was exceeded. Method 400 may then continue to block 440, where method 400 may stop.

In some cases, when deciding whether to adjust the active allocation, controller device 240 not only uses the load thresholds as described above but also takes into account the state of the table entries at each switch. If the flow table at a networking device is not full, there is no need to adjust the active allocation. If the table is full, then controller device 240 can perform adjustments subject to minimum constraints on the flow table capacity used for each type of entry (i.e., active or backup). In general, the minimum constraints can be static, user-configurable, or dynamically tuned based on an automated estimation of the consequence of different allocations on controller load and failover time. For example, controller device 240 may monitor the packet-in load generated from each networking device individually. Networking devices with high packet-in loads may merit a larger allocation of active flow table entries than networking devices with low packet-in loads.

Method 400 may be applied separately to any number of networking devices in an SDN. In this case, controller device 240 monitors packet-in events at each networking device and adjusts the active allocation at each networking device as described above.

The foregoing disclosure describes a number of example embodiments for providing dynamic allocation of flow table capacity. In this manner, the embodiments disclosed herein improve the performance of active flows in an SDN by modifying an active allocation of networking devices according to a monitoring of packet-in events.

We claim:

1. A system for dynamic allocation of flow table capacity, comprising:
an interface for connecting to a networking device of a plurality of networking devices; and
a processor operatively connected to the memory, the processor to:
monitor a plurality of packet-in events of the networking device;
after detecting that the plurality of packet-in events on the networking device exceeds an overload threshold, increase the active allocation of the flow table, wherein an active allocation is dedicated to a plurality of active flow entries; and
remove a backup flow entry of a plurality of backup flow entries from the flow table based on the active allocation.

2. The system of claim 1, the processor is further to:
after detecting that the plurality of packet-in events on the networking device falls below a normal threshold, decrease the active allocation of the flow table by removing an underutilized flow of the plurality of active flow entries, wherein the underutilized flow is identified based on flow usage statistics.

3. The system of claim 1, wherein the active allocation is increased gradually as the plurality of packet-in events increases.

4. The system of claim 1, wherein the active allocation is increased proportionally according to a magnitude that the plurality of packet-in events exceeds the overload threshold.

5. The system of claim 1, wherein the active allocation has a maximum value that cannot be surpassed when increasing the active allocation.

6. The system of claim 1, wherein the processor is further to select the backup flow entry for removal by using flow usage statistics to determine that the backup flow entry is inactive.

7. A method for dynamic allocation of flow table capacity, comprising:
monitoring a plurality of packet-in events of a networking device, wherein the plurality of packet-in events are to be processed to create a plurality of active flow entries in a flow table;
after detecting that the plurality of packet-in events on the networking device exceeds an overload threshold, increasing the active allocation of the flow table;
removing a backup flow entry of a plurality of backup flow entries from the flow table based on the active allocation; and
after detecting that the plurality of active flow entries on the networking device falls below a normal threshold, decreasing the active allocation of the flow table by removing an underutilized flow of the plurality of active flow entries, wherein the underutilized flow is identified based on flow usage statistics.

8. The method of claim 7, wherein the active allocation is increased gradually as the plurality of packet-in events increases.

9. The method of claim 7, wherein the active allocation is increased proportionally according to a magnitude that the plurality of packet-in events exceeds the overload threshold.

10. The method of claim 7, wherein the active allocation has a maximum value that cannot be surpassed when increasing the active allocation.

11. The method of claim 7, further comprising selecting the backup flow entry for removal by using flow usage statistics to determine that the backup flow entry is inactive.

12. A non-transitory machine-readable storage medium encoded with instructions executable by a processor for dynamic allocation of flow table capacity, comprising, the machine-readable storage medium comprising instructions to:
monitor a plurality of packet-in events of a networking device, wherein the plurality of packet-in events are to be processed to create a plurality of active flow entries in a flow table;
after detecting that the plurality of packet-in events on the networking device exceeds an overload threshold, gradually increase the active allocation of the flow table as the plurality of active flow entries increases;
remove a backup flow entry of a plurality of backup flow entries from the flow table based on the active allocation; and
after detecting that the plurality of packet-in events on the networking device falls below a normal threshold, decrease the active allocation of the flow table by removing an underutilized flow of the plurality of active flow entries, wherein the underutilized flow is identified based on flow usage statistics.

13. The non-transitory machine-readable storage medium of claim 12, wherein the active allocation is increased proportionally according to a magnitude that the plurality of packet-in events exceeds the overload threshold.

14. The non-transitory machine-readable storage medium of claim 12, wherein the active allocation has a maximum value that cannot be surpassed when increasing the active allocation.

15. The non-transitory machine-readable storage medium of claim 12, wherein the instructions are further to select the backup flow entry for removal by using flow usage statistics to determine that the backup flow entry is inactive.
